(19) United States
(12) Patent Application Publication
(10) Pub. No.: US 2017/0332333 A1
(43) Pub. Date: Nov. 16, 2017

(54) MANAGING SPECIFIC ABSORPTION RATE FOR USER EQUIPMENTS

(71) Applicant: QUALCOMM Incorporated, San Diego, CA (US)

(72) Inventors: Arvind Vardarajan SANTHANAM, San Diego, CA (US); Valentin Alexandru GHEORGHIU, Tokyo (JP); Sumit VERMA, San Diego, CA (US)

(21) Appl. No.: 15/591,931

(22) Filed: May 10, 2017

Related U.S. Application Data
(60) Provisional application No. 62/336,063, filed on May 13, 2016.

(51) Int. Cl. H04W 52/18; H04W 52/36; H04L 5/14

(52) U.S. Cl. CPC H04W 52/18; H04L 5/14; H04W 52/365

(57) ABSTRACT

Aspects of the present disclosure provide apparatus and techniques for specific absorption rate (SAR) control for user equipments (UEs) (e.g., high-power UEs). A method for wireless communications by a UE is provided. The method generally includes determining a time division duplexing (TDD) subframe configuration defining a first number of uplink subframes and a second number downlink subframes and adjusting a transmit power level of the UE based on the TDD subframe configuration. Another method generally includes estimating SAR of the UE for a time window and taking one or more actions to reduce a number of uplink transmissions for the UE in order to achieve a target SAR for the time window.

### CROSS-REFERENCE TO RELATED APPLICATION & PRIORITY CLAIM

This application claims benefit of and priority to U.S. Provisional Patent Application Ser. No. 62/336,063, filed May 13, 2016, which is herein incorporated by reference in its entirety for all applicable purposes.

### BACKGROUND

### Field of the Disclosure

Certain aspects of the present disclosure generally relate to wireless communications and, more particularly, to managing specific absorption rate (SAR) control for devices, such as user equipments (UEs) (e.g., high-power UEs).

### Description of Related Art

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, single-carrier FDMA (SC-FDMA), time division synchronous CDMA (TD-SCDMA), 3rd Generation Partnership Project (3GPP) Long Term Evolution (LTE)/LTE-Advanced (LTE-A) systems and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input single-output, multiple-input single-output or a multiple-input multiple-output (MIMO) system.

These multiple access technologies have been adopted in various telecommunication standards to provide a common protocol that enables different wireless devices to communicate on a municipal, national, regional, and even global level. An example of an emerging telecommunication standard is new radio (NR). NR is a set of enhancements to the LTE mobile standard promulgated by 3GPP. NR is designed to better support mobile broadband Internet access by improving spectral efficiency, lower costs, improve services, make use of new spectrum, and better integrate with other open standards using OFDMA with a cyclic prefix on the downlink and on the uplink, as well as supporting beamforming, MIMO antenna technology, and carrier aggregation. However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Certain aspects of the present disclosure provide techniques and apparatus for managing and/or controlling specific absorption rate (SAR) for devices, such as user equipments (UEs) (e.g., high-power UEs).

Certain aspects of the present disclosure provide a method for wireless communications by a UE. The method generally includes determining a time division duplexing (TDD) subframe configuration defining a first number of uplink (UL) subframes and a second number of downlink (DL) subframes (e.g., a TDD UL/DL configuration); and adjusting a transmit power (e.g., maximum transmit power) level of the UE based on the TDD subframe configuration.

Certain aspects of the present disclose provide another method for wireless communications by a UE. The method generally includes determining an SAR of the UE for a time window; and taking one or more actions to reduce a number of uplink transmissions for the UE in order to achieve a target SAR for the time window.

Certain aspects of the present disclosure provide an apparatus for wireless communications by a UE. The apparatus generally includes means for determining a TDD subframe configuration defining a first number of UL subframes and a second number of DL subframes; and means for adjusting a transmit power level of the UE based on the TDD subframe configuration.

Certain aspects of the present disclose provide another apparatus for wireless communications by a UE. The apparatus generally includes means for determining an SAR of the UE for a time window; and means for taking one or more actions to reduce a number of uplink transmissions for the UE in order to achieve a target SAR for the time window.

Certain aspects of the present disclosure provide an apparatus for wireless communications by a UE. The apparatus generally includes at least one processor coupled with a memory and configured to determine a TDD subframe configuration defining a first number of UL subframes and a second number of DL subframes; and adjust a transmit power level of the UE based on the TDD subframe configuration.

Certain aspects of the present disclose provide another apparatus for wireless communications by a UE. The apparatus generally includes at least one processor coupled with a memory and configured to determine an SAR of the UE for a time window; and take one or more actions to reduce a number of uplink transmissions for the UE in order to achieve a target SAR for the time window.

Certain aspects of the present disclosure provide a computer readable medium having computer executable code stored thereon for wireless communications by a UE. The computer executable code generally includes code for determining a TDD subframe configuration defining a first number of UL subframes and a second number of DL subframes; and code for adjusting a transmit power level of the UE based on the TDD subframe configuration.

Certain aspects of the present disclose provide another computer readable medium having computer executable code stored thereon for wireless communications by a UE. The computer executable code generally includes code for determining an SAR of the UE for a time window; and code for taking one or more actions to reduce a number of uplink transmissions for the UE in order to achieve a target SAR for the time window.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example of a wireless communication network, in accordance with certain aspects of the present disclosure.

FIG. 2 shows a block diagram conceptually illustrating an example of a base station (BS) in communication with a user equipment (UE) in a wireless communications network, in accordance with certain aspects of the present disclosure.

FIG. 3 is a block diagram conceptually illustrating an example of a frame structure in a wireless communications network, in accordance with certain aspects of the present disclosure.

FIG. 4 is a block diagram conceptually illustrating two exemplary subframe formats with the normal cyclic prefix, in accordance with certain aspects of the present disclosure.

FIG. 4A is a diagram illustrating an example of an uplink (UL) frame structure in LTE, in accordance with certain aspects of the present disclosure.

FIG. 5 is a flow diagram illustrating example operations for wireless communications by a UE, in accordance with certain aspects of the present disclosure.

FIG. 6 is a flow diagram illustrating example operations for wireless communications by a UE, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Aspects of the present disclosure provide techniques for user equipments (UEs), such as high power UEs, to perform specific absorption rate (SAR) control and/or management. For example, the UE can determine a time division duplexing (TDD) subframe configuration and adjust its transmit power level (e.g., its maximum transmit power level) based on the TDD subframe configuration. In this case, the UE can take in account the number of uplink subframes associated with the TDD subframe configuration in determining/adjusting the transmit power level, such that the UE can comply with the SAR limit. Alternatively, the UE can determine/estimate the SAR of the UE for a time window and take one or more actions to reduce a number of uplink transmissions for the UE in order to achieve a target SAR for the time window.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as universal terrestrial radio access (UTRA), cdma2000, etc. UTRA includes wideband CDMA (WCDMA), time division synchronous CDMA (TD-SCDMA), and other variants of CDMA. cdma2000 covers IS-2000, IS-95 and IS-856 standards. A TDMA network may implement a radio technology such as global system for mobile communications (GSM). An OFDMA network may implement a radio technology such as evolved UTRA (E-UTRA), ultra mobile broadband (UMB), IEEE 802.11 (Wi-Fi), IEEE 802.16 (WiMAX), IEEE 802.20, Flash-OFDM®, etc. UTRA and E-UTRA are part of universal mobile telecommunication system (UMTS). 3GPP Long Term Evolution (LTE) and LTE-Advanced (LTE-A), in both frequency division duplex (FDD) and time division duplex (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development in conjunction with the 5G Technology Forum (5GTF). The techniques described herein may be used for the wireless networks and radio technologies mentioned above as well as other wireless networks and radio technologies. For clarity, certain aspects of the techniques are described below for LTE/LTE-Advanced, and LTE/LTE-Advanced terminology is used in much of the description below. LTE and LTE-A are referred to generally as LTE.

It is noted that while aspects may be described herein using terminology commonly associated with 3G and/or 4G wireless technologies, aspects of the present disclosure can be applied in other generation-based communication systems, such as NR including 5G and later.

### Example Wireless Communications System

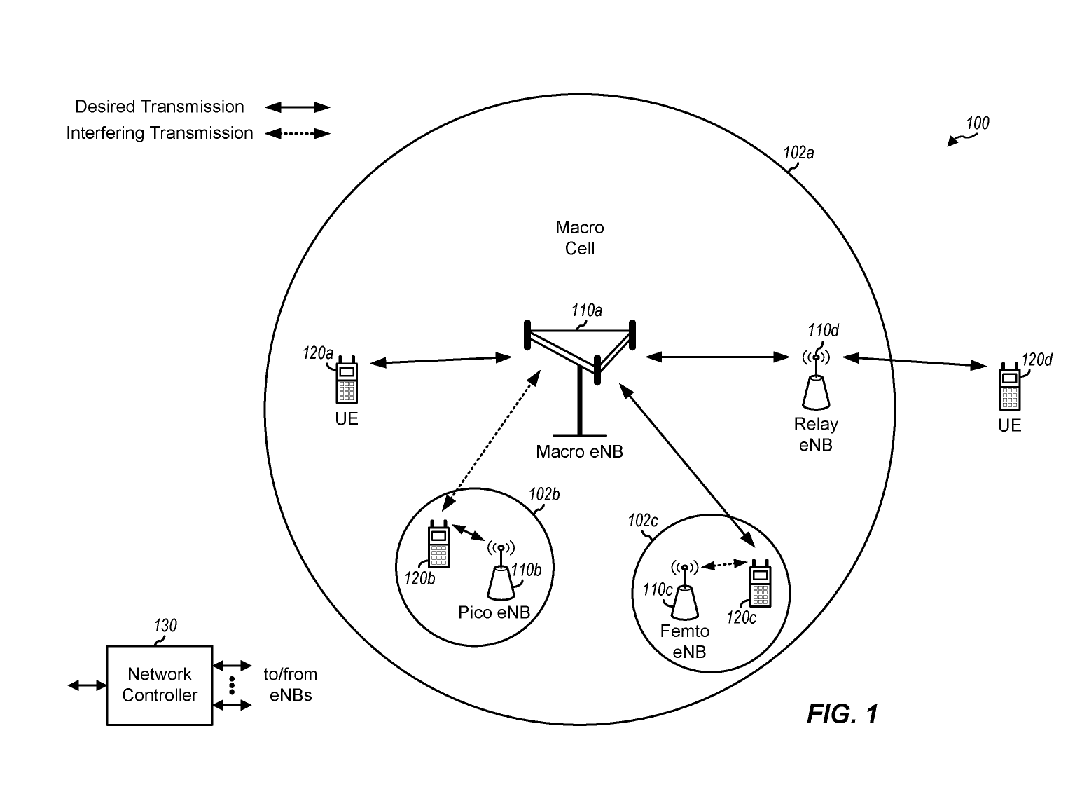

FIG. 1 illustrates an example wireless communication network 100, in which aspects of the present disclosure may be practiced. For example, techniques presented herein may be used to help user equipments (UEs), such as high power UEs, shown in FIG. 1 communicate while maintaining and/or complying with a regulatory specific absorption rate (SAR) limit. For example, a UE 120 can determine a time division duplexing (TDD) subframe configuration defining a first number of uplink subframes and a second number downlink subframes (e.g., a TDD UL/DL subframe configuration) and adjust a transmit power level (e.g., maximum transmit power level) of the UE 120 based on the TDD subframe configuration. Alternatively, the UE 120 can determine a SAR of the UE 120 for a time window and take one or more actions (e.g., such as sending a faked buffer status report (BSR) or power headroom report (PHR) to the base station (BS) 110 or skipping or delaying some uplink transmissions scheduled in the time window) to reduce a number of uplink transmissions for the UE in order to achieve a target SAR for the time window.

The wireless communication network 100 may be a long term evolution (LTE) network or some other wireless network such as a new radio (NR) or 5G network. Wireless communication network 100 may include a number of BSs 110 and other network entities. A BS is an entity that communicates with UEs and may also be referred to as a Node B, an access point (AP), enhanced/evolved NB (eNB), 5G NB, gNB, transmission reception point (TRP), etc. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “BS” and “cell” may be used interchangeably herein.

Wireless communication network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay eNB, a relay base station, a relay, etc.

Wireless communication network 100 may be a heterogeneous network that includes BSs of different types, e.g., macro BSs, pico BSs, femto BSs, relay BSs, etc. These different types of BSs may have different transmit power levels, different coverage areas, and different impact on interference in wireless communication network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless communication network 100, and each UE may be stationary or mobile. A UE may also be referred to as an access terminal, a terminal, a mobile station, a subscriber unit, a station, etc. A UE may be a cellular phone, a smart phone, a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered evolved or machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices.

A UE may be located within the coverage of multiple BSs. One of these eNBs may be selected to serve the UE. The serving BS may be selected based on various criteria such as received signal strength, received signal quality, pathloss, etc. Received signal quality may be quantified by a signal-to-noise-and-interference ratio (SINR), or a reference signal received quality (RSRQ), or some other metric. The UE may operate in a dominant interference scenario in which the UE may observe high interference from one or more interfering BSs.

In FIG. 1, a solid line with double arrows indicates desired transmissions between a UE and a serving BS, which is a BS designated to serve the UE on the downlink and/or uplink. A dashed line with double arrows indicates potentially interfering transmissions between a UE and a BS.

In some examples, access to the air interface may be scheduled, wherein a scheduling entity (e.g., a BS) allocates resources for communication among some or all devices and equipment within its service area or cell. Within the present disclosure, as discussed further below, the scheduling entity may be responsible for scheduling, assigning, reconfiguring, and/or releasing resources for one or more subordinate entities. That is, for scheduled communication, subordinate entities utilize resources allocated by the scheduling entity.

BSs are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time—frequency resources and having a cellular configuration, a P2P configuration, and a mesh configuration, a scheduling entity and one or more subordinate entities may communicate utilizing the scheduled resources.

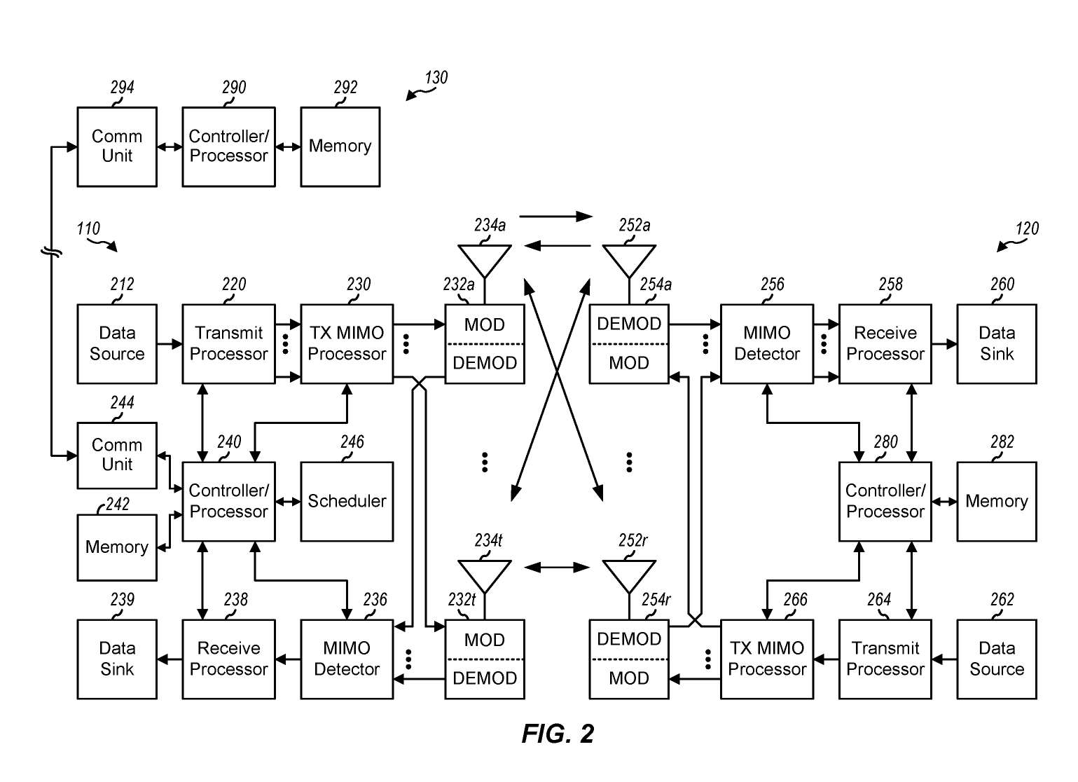

FIG. 2 shows a block diagram of a design of BS 110 and UE 120, which may be one of the BSs and one of the UEs shown in FIG. 1. BS 110 may be equipped with T antennas 234a through 234t, and UE 120 may be equipped with R antennas 252a through 252r, where in general T≧1 and R≧1.

At BS 110, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for static resource partitioning information (SRPI), etc.) and control information (e.g., CQI requests, grants, upper layer signaling, etc.) and provide overhead symbols and control symbols. Processor 220 may also generate reference symbols for reference signals (e.g., the common reference signal (CRS)) and synchronization signals (e.g., the primary synchronization signal (PSS) and the secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) its received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), CQI, etc.

On the uplink, at UE 120, a transmit processor 264 may receive and process data from a data source 262 and control information (e.g., for reports comprising RSRP, RSSI, RSRQ, CQI, etc.) from controller/processor 280. Processor 264 may also generate reference symbols for one or more reference signals. The symbols from transmit processor 264 may be precoded by a TX MIMO processor 266 if applicable, further processed by modulators 254a through 254r (e.g., for SC-FDM, OFDM, etc.), and transmitted to BS 110. At BS 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Processor 238 may provide the decoded data to a data sink 239 and the decoded control information to controller/processor 240. BS 110 may include communication unit 244 and communicate to network controller 130 via communication unit 244. Network controller 130 may include communication unit 294, controller/processor 290, and memory 292.

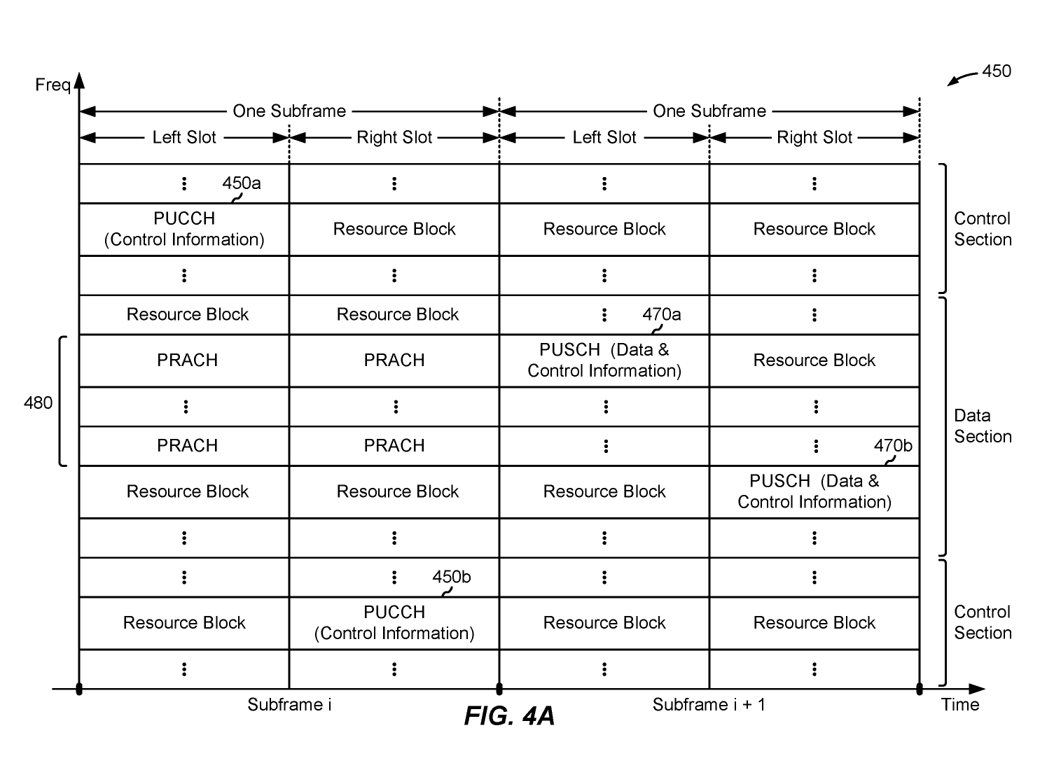

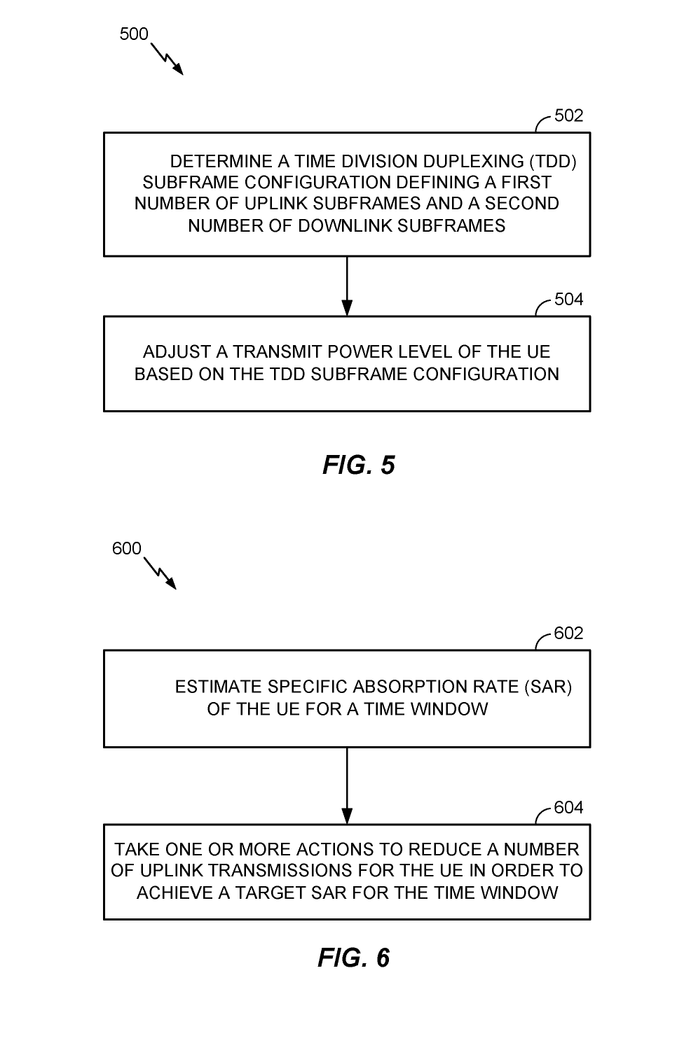

Controllers/processors 240 and 280 may direct the operation at base station 110 and UE 120, respectively. For example, controller/processor 280 and/or other processors and modules at UE 120, may perform or direct operations 500 shown in FIG. 5 and/or operations 600 shown in FIG. 6. Memories 242 and 282 may store data and program codes for BS 110 and UE 120, respectively. A scheduler 246 may schedule UEs for data transmission on the downlink and/or uplink. In some aspects, one or more of the components shown in FIG. 2 may be employed to perform example operations 500, 600, and/or other processes for the techniques described herein.

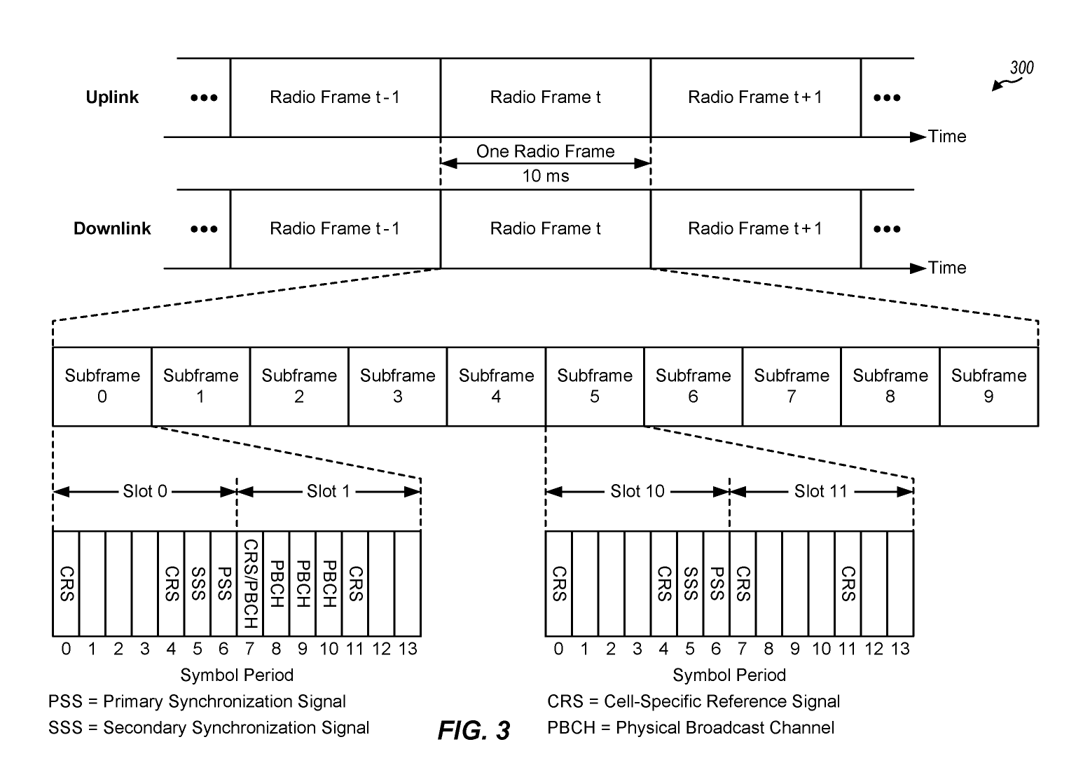

FIG. 3 shows an exemplary frame structure 300 for frequency division duplexing (FDD) in certain wireless communication networks (e.g., wireless communication network 100). The transmission timeline for each of the downlink and uplink may be partitioned into units of radio frames (e.g., as shown in FIG. 3, radio frames t-1, t, t-1, . . . ). Each radio frame may have a predetermined duration (e.g., 10 milliseconds (ms)) and may be partitioned into 10 subframes with indices of 0 through 9 (e.g., as shown in FIG. 3, radio frame t is partitioned into subframe 0 through subframe 10). Each subframe may include two slots. Each radio frame may thus include 20 slots with indices of 0 through 19 (e.g., as shown in FIG. 3, subframe 0 includes slot 0 and slot 1 and subframe 5 includes slot 10 and slot 11). Each slot may include L symbol periods, for example, seven symbol periods for a normal cyclic prefix (as shown in FIG. 3) or six symbol periods for an extended cyclic prefix. The 2L symbol periods in each subframe may be assigned indices of 0 through 2L-1 (e.g., as shown in FIG. 3, slot 0 includes symbols 0-6, slot 1 includes symbols 7-13, slot 10 includes symbols 0-6, and slot 11 includes symbols 7-13).

In certain networks (e.g., LTE), a BS may transmit a PSS and a SSS on the downlink in the center of the system bandwidth for each cell supported by the BS. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. The BS may transmit a CRS across the system bandwidth for each cell supported by the BS. The CRS may be transmitted in certain symbol periods of each subframe and may be used by the UEs to perform channel estimation, channel quality measurement, and/or other functions. The BS may also transmit a physical broadcast channel (PBCH) in symbol periods 0 to 3 in slot 1 of certain radio frames. The PBCH may carry some system information. The BS may transmit other system information such as system information blocks (SIBs) on a physical downlink shared channel (PDSCH) in certain subframes. The BS may transmit control information/data on a physical downlink control channel (PDCCH) in the first B symbol periods of a subframe, where B may be configurable for each subframe. The eNB may transmit traffic data and/or other data on the PDSCH in the remaining symbol periods of each subframe. In aspects, one or more of the above-described signals and/or channels may be transmitted in a different time and/or frequency resource.

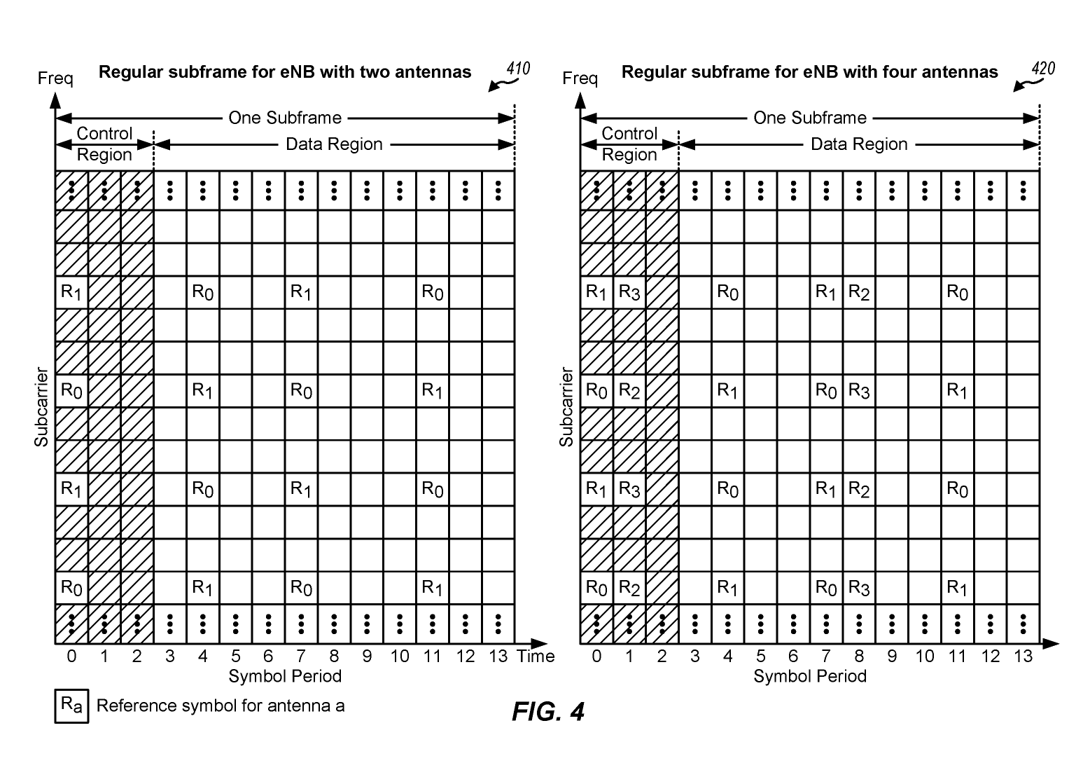

FIG. 4 shows two exemplary subframe formats 410 and 420 with the normal cyclic prefix. The available time frequency resources may be partitioned into resource blocks (RBs). Each RB may cover 12 subcarriers in one slot and may include a number of resource elements (REs). Each RE may cover one subcarrier in one symbol period and may be used to send one modulation symbol, which may be a real or complex value.

Subframe format 410 may be used for two antennas. A CRS may be transmitted from antennas 0 and 1 in symbol periods 0, 4, 7 and 11. A reference signal is a signal that is known a priori by a transmitter and a receiver and may also be referred to as pilot. A CRS is a reference signal that is specific for a cell, e.g., generated based on a cell identity (ID). In FIG. 4, for a given RE with label Ra, a modulation symbol may be transmitted on that RE from antenna a, and no modulation symbols may be transmitted on that RE from other antennas. Subframe format 420 may be used with four antennas. A CRS may be transmitted from antennas 0 and 1 in symbol periods 0, 4, 7 and 11 and from antennas 2 and 3 in symbol periods 1 and 8. For both subframe formats 410 and 420, a CRS may be transmitted on evenly spaced subcarriers, which may be determined based on cell ID. CRSs may be transmitted on the same or different subcarriers, depending on their cell IDs. For both subframe formats 410 and 420, resource elements not used for the CRS may be used to transmit data (e.g., traffic data, control data, and/or other data).

The PSS, SSS, CRS and PBCH in LTE are described in 3GPP TS 36.211, entitled “Evolved Universal Terrestrial Radio Access (E-UTRA); Physical Channels and Modulation,” which is publicly available.

An interlace structure may be used for each of the downlink and uplink for FDD in certain networks (e.g., LTE). For example, Q interlaces with indices of 0 through Q-1 may be defined, where Q may be equal to 4, 6, 8, 10, or some other value. Each interlace may include subframes that are spaced apart by Q frames. In particular, interlace q may include subframes q, q+Q, q+2Q, etc., where qε (0, . . . , Q-1).

The wireless communication network 100 may support hybrid automatic retransmission request (HARQ) for data transmission on the downlink and uplink. For HARQ, a transmitter (e.g., a BS) may send one or more transmissions of a packet until the packet is decoded correctly by a receiver (e.g., a UE) or some other termination condition is encountered. For synchronous HARQ, all transmissions of the packet may be sent in subframes of a single interlace. For asynchronous HARQ, each transmission of the packet may be sent in any subframe.

FIG. 4A is a diagram illustrating an example of an uplink (UL) frame structure 450 in certain networks (e.g., LTE). The available RBs for the UL may be partitioned into a data section and a control section. The control section may be formed at the two edges of the system bandwidth and may have a configurable size. The RBs in the control section may be assigned to UEs for transmission of control information. The data section may include all RBs not included in the control section. The UL frame structure results in the data section including contiguous subcarriers, which may allow a single UE to be assigned all of the contiguous subcarriers in the data section.

A UE may be assigned RBs 450a, 450b in the control section to transmit control information to a BS. The UE may also be assigned RBs 470a, 470b in the data section to transmit data to the BS. The UE may transmit control information in a physical UL control channel (PUCCH) on the assigned RBs in the control section. The UE may transmit only data or both data and control information in a physical UL shared channel (PUSCH) on the assigned RBs in the data section. A UL transmission may span both slots of a subframe and may hop across frequencies.

A set of RBs may be used to perform initial system access and achieve UL synchronization in a physical random access channel (PRACH) 480. The PRACH 480 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (e.g., of 1 ms) or in a sequence of few contiguous subframes and a UE can make only a single PRACH attempt per frame (e.g., of 10 ms). In aspects, one or more of the above-described signals and/or channels may be transmitted in a different time and/or frequency resource.

As indicated above, FIGS. 4 and 4A are provided as examples. Other examples are possible and may differ from what was described above in connection with FIGS. 4 and 4A.

Wireless communication devices (e.g., mobile cell phones, personal data assistants, laptops, and the like) are generally subject to regulatory radio frequency (RF) safety requirements. These systems must operate within specific guidelines before they can enter the market. For example, devices operating near the human body are evaluated to determine the Specific Absorption Rate (SAR) that their electromagnetic waves produce. The SAR is the time-rate of electromagnetic energy absorption per unit of mass in a lossy media, and may be expressed as follows:

$$S A R ( r ) = \frac{σ ( r )}{ρ ( r )} {\vert E ( r ) \vert}_{rms}^{2} \qquad Eqn . ( 1 )$$

where E(r) is the exogenous electric field at point r, rms stands for root mean square, while σ(r) and ρ(r) are the corresponding equivalent electrical conductivity and mass density, respectively. Generally, SAR testing evaluates the amount of energy absorbed into the body from a device with a single or multiple transmitters. Under an alternate requirement, devices operating at distances beyond 20 centimeters may be evaluated through a maximum permissible exposure (MPE) calculation or measurement.

To certify a device, the device must comply with RF exposure requirements, for example, even while all the transmitters transmit simultaneously and operate at their maximum allowable transmitter power. Compliance with the SAR requirement may be a challenge for devices, for example, that transmit at high power. However, scenarios are increasing in which devices, such as UEs, desire to transmit at high power.

A system and method are provided so that the maximum transmit power for one or more transmitters are established to achieve compliance with the regulatory limit in a simultaneous transmitter configuration.

### Example SAR Control and/or Management for UEs

In certain systems, a maximum transmit power level is specified for user devices, such as user equipment (UE) (e.g., a UE 120). Certain systems may specify the maximum transmit power level for user devices to 23 dBm (e.g., which may be referred to as power class 3). The maximum transmit power level may be specified due to the regulatory specific absorption rate (SAR) limitations. The maximum transmit power level limit may apply to both time division duplexing (TDD) operation and frequency division duplexing (FDD) operation—even though the transmitter duty cycle is lower in TDD operation.

Certain systems may have an increased maximum transmit power specified for TDD operation. For example, certain systems may have an increased maximum transmit power of 26 dBm (e.g., which may be referred to as power class 2) for TDD operation. However, such increased maximum transmit power increases the risk on violating a regulatory SAR limit.

Accordingly, techniques and apparatus for SAR control and/or management for UEs, such as high power UEs (e.g., UEs that can have peak transmit power levels higher than 23 dBm), are desirable.

Aspects of the present disclosure provide techniques for the UE to control the transmit power and/or or duty cycle of the UE to meet (e.g., comply with) the SAR requirement.

According to certain aspects, different territories or countries have different SAR requirements. Therefore, solutions may vary based on the territory or country where the UE operates. Or in other words, the target SAR limit and/or corresponding transmit power/duty cycle that the UE is controlling can be adjusted based on the applicable SAR limit for the territory or country in which the UE is operating.

### Example SAR Control by Maximum Transmit Power Fallback Based on TDD UL/DL Subframe Configuration

According to certain aspects, the UE can manage/control its SAR by adjusting the maximum transmit power based on the TDD subframe configuration configured for the UE.

The TDD subframe configuration defines subframes in a frame as uplink subframes, downlink subframes, and/or special. If the TDD uplink downlink subframe configuration used on a carrier has less than half UL subframes, then the SAR for a TDD UE transmitting at higher power, averaged over a long enough period of time, may be the same or lower compared to a FDD UE—transmitting in every subframe at the lower maximum transmit power level. However, if the TDD UL/DL configuration has more than half UL subframes, then the higher power UE may need to control its transmit power (or duty cycle) to meet the SAR requirements.

According to certain aspects, one technique that may be used for SAR control for a UE (e.g., a high power UE) may be to transmit at a transmit power level (e.g., a maximum transmit power level) that is based on the TDD UL/DL subframe configuration. For example, the UE may transmit at a higher transmit power level (e.g., 26 dBm) if the TDD UL/DL subframe configuration used in the network has less than half uplink subframe and/or the UE may transmit at (e.g., fall back to) a lower transmit power level (e.g., 23 dBm) if the TDD UL/DL subframe configuration used in the network has half or more than half uplink subframes (e.g., TDD UL/DL configuration #0 or 6).

FIG. 5 is a flow diagram of example operations 500 for wireless communications, in accordance with certain aspects of the present disclosure. The operations 500 may be performed, for example, by a UE (e.g., UE 120). The operations 500 may begin, at 502, by determining a TDD subframe configuration defining a first number of uplink subframes and a second number of downlink subframes.

At 504, the UE adjusts a transmit power level (e.g., maximum transmit power level) of the UE based on the TDD subframe configuration. The adjusting can include selecting a higher maximum transmit power level (e.g., 26 dBm) if the first number of uplink subframes is less than the second number of downlink subframes and/or selecting a lower maximum transmit power level if the first number of uplink subframes is greater than the second number of downlink subframes. In aspects, the adjusting can include selecting a higher transmit power level if the first number of uplink subframes does not satisfy a threshold (e.g., a threshold number of uplink subframes for a given time period) and/or selecting a lower transmit power level if the first number of uplink subframes satisfies the threshold

### Example SAR Control and/or Management Based on Sliding Window and/or Instantaneous Values

According to certain aspects, the UE can estimate the SAR emissions using a sliding window and/or instantaneous values (e.g., for each of one or more portions of one or more subframes). For example, the UE may access a lookup table and/or integrate over a time window. The time window may depend on the particular regulator SAR limits (e.g., test) used for the specific territory or country. Based on the estimated SAR emissions over the time window, the UE may control and/or manage (e.g., reduce) the transmit or output power in order to meet or comply with the SAR requirement.

When the UE is not scheduled in every available uplink subframe, even if the TDD UL/DL configuration is more than half uplink subframes and/or even if the UE transmits at a high maximum transmit power level (e.g., higher than 23 dBm), the UE may still meet the SAR requirement. According to certain aspects, therefore, the UE may perform SAR control at least in part by reducing its number of scheduled subframes and/or causing a reduction in the number of scheduled subframes for the UE.

In one example, the UE may trigger and/or transmit a power headroom report (PHR) informing the network that the UE has less power available for transmission than the UE actually has available (e.g., a “faked” value). The PHR indicates how much of the maximum transmit power is left for a UE to use in addition to the power already being used by current transmission.

In another example, the UE may signal the network, to request or cause the network to perform sparser scheduling for the UE. For example, the UE may request or cause the network to perform sparser scheduling when the UE is in a power limited scenario, such as when the UE is at the edge of coverage and using very low coding rates to transmit. In this case, if the UE reduces its transmit power (e.g., maximum transmit power), the UE may lose the connection, so it may be desirable to maintain a higher transmit power level (e.g., the highest maximum transmit power level), but reduce the number of scheduled uplink transmissions in order to meet or comply with the SAR limit.

In another example, the UE can limit the number and/or frequency of UL transmissions by reducing a rate of or causing a reduction in the rate of the UL data transmissions (e.g., obtaining a lower rate for data transmission) using a buffer status report (BSR). The BSR provides information regarding how much data is in a UE buffer to be sent. The UE may reduce the transmission rate or cause the transmission rate to be reduced by sending a BSR indicating a smaller amount data than is actually in the buffer (e.g., a “faked” value) in order to receive a smaller uplink grant than the UE might receive if the actual amount of data was sent in the BSR.

According to certain additional or alternative aspects, in order to meet the SAR limit, the UE may reduce transmit power (e.g., maximum transmit power) by prioritizing certain channels (e.g., transmitting those prioritized channels at higher power and lower priority channels at lower power). For example, the UE may assign a higher priority to control channels transmissions. The transmit power configuration for the prioritized channels may be semi-static, such that the power used for these channels may be accounted for in advance.

According to certain aspects, the UE may lower its SAR by foregoing (e.g., dropping/skipping/refraining from transmitting) some scheduled uplink transmissions. The UE may selectively determine the scheduled uplink transmissions to drop, for example, based on a payload priority. Alternatively, the UE can lower transmit power in those scheduled uplink transmissions to meet or comply with the SAR constraints.

According to certain aspects, the UE may lower its SAR by delaying transmission of certain messages. For example, some messages (e.g., measurement reports of neighbor cells used for mobility purposes) are triggered by particular events (e.g., mobility events) and should be transmitted with certain delays. The UE may delay the transmission rather than drop the transmission depending on the contents of the messages.

According to certain aspects, the UE may use any combination of the above examples in order to comply with the SAR limits for the UE.

FIG. 6 is a flow diagram of example operations 600 for wireless communications, in accordance with certain aspects of the present disclosure. The operations 600 may be performed, for example, by a UE (e.g., UE 120). The operations 600 may begin, at 602, by estimating or determining a specific absorption rate (SAR) of the UE for a time window (e.g., based on an instantaneous SAR estimate integrated over the time window).

At 604, the UE takes one or more actions to reduce a number of uplink transmissions for the UE in order to achieve a target SAR for the time window. For example, the UE can request or cause a BS to schedule fewer uplink subframes (e.g., sparser scheduling) at the UE. The UE can transmit a PHR indicating a smaller amount of available power at the UE than an amount of power actually available at the UE. The UE can transmit a BSR indicating a smaller amount of data in the UE buffer than an amount of data actually in the UE buffer. The UE can forgo (e.g., drop) or delay transmission of scheduled uplink transmissions in one or more subframes within the time window (e.g., based on a priority of the payload content) to a time later in the time window or outside the time window. The UE can also adjust a transmit power level (e.g., maximum transmit power level) of the UE based on the estimated SAR in order to achieve the target SAR. The UE can assign a priority to one or more channels (e.g., control channels) and adjust the transmit power level of the one or more channels based on the priority of that channel, where higher priority channels are transmitted at higher power than lower priority channels.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for determining a TDD subframe configuration defining a first number of uplink subframes and a second number downlink subframes, means for determining an SAR of the UE for a time window, and/or means for taking action to reduce a number of uplink transmissions for the UE in order to achieve a target SAR may be a processing system of the BS, for example, which may include Controller/Processor 240 and/or Scheduler 246 of the BS 110 illustrated in FIG. 2. Means for adjusting a maximum transmit power level of the UE based on the TDD subframe configuration may be a transmitter of the BS, for example, which may include the antenna(s) 234a-234t, Modulator(s) 232t-232t, TX MIMO Processor 230, and/or Transmit Processor 220 of the BS 110 illustrated in FIG. 2. In aspects, means for determining a TDD subframe configuration defining a first number of uplink subframes and a second number downlink subframes, means for determining an SAR of the UE for a time window, and/or means for taking action to reduce a number of uplink transmissions for the UE in order to achieve a target SAR may be a processing system of the UE, for example, which may include Controller/Processor 280, receive processor 258, transmit processor 264 and/or TX MIMO Processor 266 illustrated in FIG. 2. Means for adjusting a maximum transmit power level of the UE based on the TDD subframe configuration may be a transmitter of the UE, for example, which may include the antenna(s) 252a-252r, Modulator(s) 254a-254r, TX MIMO Processor 266, and/or Transmit Processor 264 of the UE 120 illustrated in FIG. 2.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a user equipment (UE), comprising:
determining a time division duplexing (TDD) subframe configuration defining a first number of uplink subframes and a second number of downlink subframes; and
adjusting a transmit power level of the UE based on the TDD subframe configuration.

2. The method of claim 1, wherein the adjusting comprises:
selecting a lower transmit power level if the first number of uplink subframes is greater than the second number of downlink subframes; and
selecting a higher transmit power level if the first number of uplink subframes is fewer than the second number of downlink subframes.

3. The method of claim 2, wherein the higher transmit power level is 26 dBm.

4. The method of claim 1, wherein the adjusting comprises:
selecting a higher transmit power level if the first number of uplink subframes does not satisfy a threshold; and
selecting a lower transmit power level if the first number of uplink subframes satisfies the threshold.

5. The method of claim 1, wherein the adjusting further comprises:
adjusting the transmit power level to comply with a regulatory specific absorption rate (SAR) limit.

6. The method of claim 1, wherein the transmit power level is a maximum transmit power level of the UE.

7. A method for wireless communications by a user equipment (UE), comprising:
estimating specific absorption rate (SAR) of the UE for a time window; and
taking one or more actions to reduce a number of uplink transmissions for the UE in order to achieve a target SAR for the time window.

8. The method of claim 7, wherein the estimating is based on an instantaneous SAR estimate for one or more portions of one or more current subframes integrated over the time window.

9. The method of claim 8, wherein the estimating is based on a lookup table.

10. The method of claim 7, wherein the taking one or more actions comprises causing a base station (BS) to schedule fewer uplink subframes for the UE during the time window.

11. The method of claim 10, wherein causing the BS to schedule fewer uplink subframe for the UE during the time window comprises:
transmitting a power headroom report (PHR) to the BS indicating a smaller amount of available power at the UE than an amount of power actually available at the UE.

12. The method of claim 10, wherein causing the BS to schedule fewer uplink subframe for the UE during the time window comprises:
transmitting a buffer status report (BSR) to the BS indicating a smaller amount of data in a UE buffer than an amount of data actually in the UE buffer.

13. The method of claim 7, further comprising:
adjusting a transmit power level of the UE based on the estimated SAR in order to achieve the target SAR.

14. The method of claim 13, wherein the adjusting comprises:
assigning a priority to one or more channels; and
adjusting the transmit power level for the one or more channels based on the assigned priority of that channel, wherein higher priority channels are transmitted at higher power than lower priority channels.

15. The method of claim 14, wherein the assigning comprises:
assigning a highest priority to control channels.

16. The method of claim 7, wherein the taking one or more actions comprises:
at least one of: refraining from transmission or delaying transmission of one or more uplink transmissions scheduled within the time window.

17. The method of claim 16, wherein the refraining or delaying is based on a priority of a payload content associated with the one or more uplink transmissions.

18. An apparatus for wireless communications by a user equipment (UE), comprising:
means for determining a time division duplexing (TDD) subframe configuration defining a first number of uplink subframes and a second number of downlink subframes; and
means for adjusting a transmit power level of the UE based on the TDD subframe configuration.

19. The apparatus of claim 18, wherein the means for adjusting comprises:
means for selecting a lower transmit power level if the first number of uplink subframes is greater than the second number of downlink subframes; and
means for selecting a higher transmit power level if the first number of uplink subframes is fewer than the second number of downlink subframes.

20. The apparatus of claim 19, wherein the higher transmit power level is 26 dBm.

21. The apparatus of claim 18, wherein the means for adjusting comprises:
means for selecting a higher transmit power level if the first number of uplink subframes does not satisfy a threshold; and
means for selecting a lower transmit power level if the first number of uplink subframes satisfies the threshold.

22. The apparatus of claim 18, wherein the means for adjusting further comprises:
means for adjusting the transmit power level to comply with a regulatory specific absorption rate (SAR) limit.

23. The apparatus of claim 18, wherein the transmit power level is a maximum transmit power level of the UE.

24. An apparatus for wireless communications by a user equipment (UE), comprising:
means for estimating specific absorption rate (SAR) of the UE for a time window; and
means for taking one or more actions to reduce a number of uplink transmissions for the UE in order to achieve a target SAR for the time window.

25. The apparatus of claim 24, wherein the means for estimating is based on an instantaneous SAR estimate for one or more portions of one or more current subframes integrated over the time window.

26. The apparatus of claim 25, wherein the estimating is based on a lookup table.

27. The apparatus of claim 24, wherein the means for taking one or more actions comprises means for causing a base station (BS) to schedule fewer uplink subframes for the UE during the time window.

28. The apparatus of claim 27, wherein means for causing the BS to schedule fewer uplink subframe for the UE during the time window comprises:
means for transmitting a power headroom report (PHR) to the BS indicating a smaller amount of available power at the UE than an amount of power actually available at the UE.

29. The apparatus of claim 27, wherein means for causing the BS to schedule fewer uplink subframe for the UE during the time window comprises:
means for transmitting a buffer status report (BSR) to the BS indicating a smaller amount of data in a UE buffer than an amount of data actually in the UE buffer.

30. The apparatus of claim 24, wherein the means for taking one or more actions comprises:
at least one of: means for refraining from transmission or delaying transmission of one or more uplink transmissions scheduled within the time window.
